(19) United States
(12) Patent Application Publication
(10) Pub. No.: US 2005/0155955 A1
(43) Pub. Date: Jul. 21, 2005

(54) Method for reducing glare and creating matte finish of controlled density on a silicon surface

(76) Inventors: Vadim M. Daskal, Brookline, MA (US); Attila E. Kiss, N. Andover, MA (US)

Correspondence Address: Roylance, Abrams, Berdo & Goodman, L.L.P., Suite 600, 1300 19th Street, N.W., Washington, DC, 20036, US

(21) Appl. No.: 10/936,725

(22) Filed: Sep. 9, 2004

Related U.S. Application Data
(63) Continuation-in-part of application No. 10/383,573, filed on Mar. 10, 2003.
(60) Provisional application No. 60/501,400, filed on Sep. 10, 2003.

(51) Int. Cl. B23K 26/36

(52) U.S. Cl. 219/121.68; 219/121.69

(57) ABSTRACT

A system and method for producing a matte finish on a silicon surgical blade or other surface, wherein the system comprises a computer, laser and lens assembly, and an x-y coordinate controller which controls the position of the laser in accordance with received instructions. The method comprises creating a design or pattern to be ablated on the surgical blade by the laser. A data set is then generated from file representing the design or pattern, and the data set instructions are sent to the x-y coordinate controller and laser and lens assembly. The x-y coordinate controller moves the laser to a location where a crater is to be formed, and the laser illuminates the surgical blade, burning a pit or crater of pre-determined diameter, depth and spacing into the surgical blade. The process then rapidly repeats itself until the design or pattern has been created in the surgical blade.

### CROSS-REFERENCE TO RELATED APPLICATIONS

The present application claims priority under 35 U.S.C. § 119 (e) to U.S. provisional patent application Ser. No. 60/501,400, filed Sep. 10, 2003, the entire content of which is expressly incorporated herein by reference. The present application is also a continuation-in-part of U.S. nonprovisional patent application Ser. No. 10/383,573, filed Mar. 10, 2003, entitled “System and Method for the Manufacture of Surgical Blades”, the entire content of which is expressly incorporated herein by reference.

### BACKGROUND OF THE INVENTION

1. Field of the Invention

The invention is related to the manufacture and use of surgical blades. The invention is also related to a system and method for creating a matte finish on a surface, including a silicon surgical blade surface, to reduce glare.

2. Description of the Related Art

The manufacture of silicon surgical blades is a relatively new innovation in the field of medical technology. The above-identified provisional and nonprovisional patent applications disclose methods for the manufacture of these blades. When manufactured in the manner described in the above-identified applications, or using other methods, the silicon surface of the blade will typically be highly reflective. This reflectiveness is an inherent property of the silicon or other crystalline material used in manufacturing surgical blades and other devices. In the case of surgical blades, this can be distracting to the surgeon if the blade is being used under a microscope with a source of illumination.

Thus, a need exists to provide a system and method for reducing or eliminating most or all of the glare produced by light reflecting from surgical blades manufactured in accordance with the methods described in the above-identified applications, as well as other methods.

### SUMMARY OF THE INVENTION

It is an object of the present invention to provide a method for creating a matte finish on a surgical blade, preferably on a blade made of silicon and/or other crystalline materials, comprising the steps of creating a data set to control a system to create a matte finish according to a predetermined pattern or design, transferring the data set to a position controller and laser, and illuminating the surface of the surgical blade with a laser beam of a known wavelength, pulse repetition rate, surface velocity and laser output power to create the pre-determined pattern or design. The variables of wavelength, pulse repetition rate, surface velocity and laser output power are selected to create pits or craters on the surgical blade, thereby creating the matte finish.

### BRIEF DESCRIPTION OF THE DRAWINGS

The various objects, advantages and novel features of the present invention will be best understood by reference to the detailed description of the preferred embodiments which follows, when read in conjunction with the accompanying drawings, in which:

FIG. 1 illustrates a system for the application of a laser beam to a surgical blade made of a crystalline material, such as silicon; and

FIG. 2 illustrates a matte finish pattern resulting from the application of the laser beam to the surgical blade with carefully selected variables.

### DETAILED DESCRIPTION OF THE PREFERRED EMBODIMENTS

Several embodiments of the present invention will now be described in detail with reference to the appended drawings. In the drawings, the same or similar elements are denoted by the same reference numerals even though they are depicted in different drawings. In the following description, a detailed description of known functions and configurations has been omitted for conciseness.

As discussed above, the surface of silicon surgical blades, especially ones manufactured in accordance with the methods described in the above-identified applications, will usually be highly reflective. This can be distracting to the surgeon if the blade is being used under a microscope with a source of illumination. Therefore, the surface of the blade can be provided with a matte finish that scatters or diffuses incident light (from a high-intensity lamp used during surgical procedure, for example), making it appear dull, as opposed to shiny. The matte finish is created by radiating the blade surface with a suitable laser, to ablate regions in the blade surface according to specific patterns and densities. The ablated regions are preferably made in the shape of a circle because that is generally the shape of the emitted laser beam, though that need not be the case. The dimension of the circular ablated regions preferably ranges from 25-50 microns in diameter, and again is dependent upon the manufacturer and type of laser used. The depth of the circular ablated regions preferably ranges from 10-25 microns. These features will be described in greater detail below.

In practice, a graphic file can be generated that randomly locates the pits or craters and achieves the desired effect of a specific ablated region density and randomness to the pattern. Alternatively, the pattern need not be random. This graphic file can be created manually, or automatically by a program in a computer. An additional feature that can be implemented is the inscription of serial numbers, manufacturer logos, or the surgeon's or hospital's name on the blade surface itself.

During the process of creating a matte finish, the reflective surface of the crystalline silicon (Si) is exposed to the laser beam. In a preferred embodiment of the invention, the laser beam will have a wavelength of 355 nm, though laser beams with other wavelengths can also be used. Examples of such lasers include excimer and YAG lasers. The laser beam is emitted at a high frequency (or pulse repetition rate), that, in the preferred embodiment of the invention, is set at or about 5 kHz. Other pulse repetition rates can also be used, including ones less than, equal to or greater than 5 kHz. For example, some lasers can use frequencies of 10 kHz, 11 kHz, 25 kHz, 30 kHz or even 100 k Hz. The embodiments of the present invention disclosed herein encompass lasers that pulse at any desired frequency. In the preferred embodiment of the invention, the velocity at which the laser beam is moved continuously over the surface of the surgical blade (the surface velocity) is set at or about 1,000 mm/sec.

Each pulse of the laser beam creates a pit or crater in the silicon surface. In a preferred embodiment of the invention, the pits or craters have a diameter in the range of 25 to 50 μm. The diameter, shape and depth of the pit or crater is dependent upon several factors. Generally, lasers are emitted in a substantially circular beam. The diameter and shape of the pit or crater is determined by the shape of the transmitted laser beam and the lens(es) used to focus the laser beam onto the silicon surface (focusing assembly). The focusing assembly can converge the laser beam into a diameter smaller than that when transmitted (which also concentrates the power of the laser into a smaller area; this is discussed below), or, conversely, enable the laser beam to diverge (which spreads the power over a greater area) into a larger area. Or, the focusing assembly can have no practical effect on the diameter of the laser beam, simply allowing it to pass through substantially unchanged.

Additionally, the focusing assembly can direct the laser beam at an angle to the surface of the object other than perpendicular. This can produce an oval shaped pit or crater, the length of the major axis being dependent upon the angle the laser beam is to the surface of the object. Finally, the duty cycle can have an effect on the shape of the pit or crater on the surface of the object. The duty cycle is the percentage of time the laser is turned on (on time) versus the total time (or period (T)) the laser is being pulsed (frequency). The duty cycle is generally expressed as a percentage of the period. A duty cycle of 1%, means that the laser is turned on for 1% of the time of the period. If the laser is pulsed on and off at a frequency of 10 kHz, with a 0.01% duty cycle, it is being turned on for 0.01 microseconds. The duty cycle can affect the shape of the pit or crater because the laser beam moves continuously over the surface of the object. However, since the duty cycle of lasers used in producing a pit or crater on an object are generally very small (for example, 0.01%, 0.0001%, and so on), the pit or crater will be substantially circular. As an example, a currently manufactured laser, the AVIA 355, provides a specification sheet, the contents of which are herein incorporated by reference, which illustrates that the pulse duration can be less than 30 nsec for a pulse repetition frequency of 60 kHz. The duty cycle for a laser that pulses on for 30 nsec and at a pulse repetition frequency of 60 kHz is 0.00018%. This example is by no means limiting, as other duty cycles and pulse repetition frequencies are within the scope of the present invention.

The depth of the crater is controllable by the peak laser output power, frequency of the laser and the focusing assembly. Peak laser output power is controlled by the power input to the resonator of the laser. Up to a certain point, this relationship is linear, and adding more power to the input signal to the resonator of the laser will generate a corresponding increase in output power of the laser. Higher laser output power will cause a deeper pit or crater. Secondly, different laser frequencies, or wavelengths, will have different “burn” characteristics in regard to different materials. Generally, lower frequency lasers have greater output power and higher frequency lasers have lower output power. Third, as discussed above, the focus assembly can have an effect on the depth of the pit or crater. A laser beam forced to diverge because of the focus assembly has less power per square millimeter. Conversely, a laser beam that is forced to converge because of the focus assembly will have more power per square millimeter. The higher power concentration will create a deeper pit or crater for a given wavelength and output power strength. Additionally, the laser can be controlled to illuminate the same location repeatedly, in order to increase the depth of the pit or crater. In the preferred embodiment of the invention, the depth of the crater is at or about 25 μm.

The spacing and size of the pits or craters determines the crater density. The density determines the silicon surface's ability to reflect light: a less dense crater pattern will reflect more light, hence a greater mirror-like surface, and a higher density pattern will reflect less light, making a darker surface.

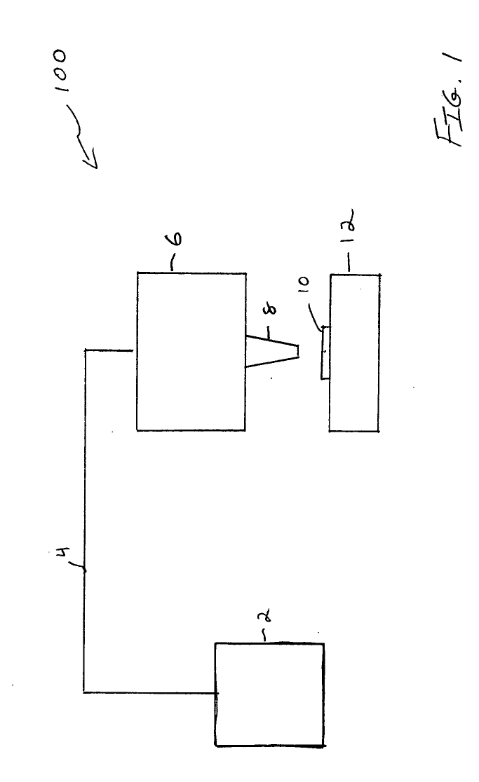

FIG. 1 illustrates an exemplary system 100 for the application of a laser beam to a surgical blade made of silicon or other crystalline material. In FIG. 1, computer 2 provides control signals via control/data lines 4 to an x-y coordinate controller 6 and a laser and lens assembly (laser assembly) 8. Computer 2 can be connected to a network (not shown), which can be the Internet, a LAN, WAN or any other type of wired/wireless network for receiving instructions to control the system 100. These network connections have been omitted for clarity. The x-y coordinate controller 6 receives position control information from computer 2, and thereby moves the laser assembly 8 accordingly.

In a preferred embodiment of the invention, there is software in the computer 2 that has been programmed to produce a matte finish pattern on an object 10. The program will take into account the type of material the object 10 is made of, the frequency of the laser beam, and the design to be imparted onto the object 10 (including the desired density), and will generate a data set to be sent to the x-y coordinate controller 6 and laser assembly 8. This data set includes a pulse repetition rate (PRR), surface velocity (SV), position control information, duty cycle corresponding to the PRR, peak and average laser output power and also instructions to alter the focus/direction of the lens assembly portion of laser assembly 8. The position control information is created from the matte finish pattern designed by the operator (or imported from another graphic program). The program takes the data of the design created by the operator and converts it into a series of commands that the x-y controller can process to control where the laser creates a pit or crater in the surface of the object. Because the operator controls the density of the design (within the limits of the laser), and the design itself, the program factors those parameters with the specifications of the laser and x-y controller to create the commands that moves the laser and instructs it when to turn on and off, for how long, and where to create the pits or craters on the surface of the object.

The “density” of circular ablated regions refers to the percentage of the total surface area covered by the circular ablated regions. An “ablated region density” of about 5% dulls the blade noticeably, from its normally smooth, mirror-like appearance. However, co-locating all the ablated regions in the same area does not affect the mirror-like effect on the balance of the blade. Therefore, the circular ablated regions are preferably spread across the surface area of the blade, in either a random or pre-determined fashion.

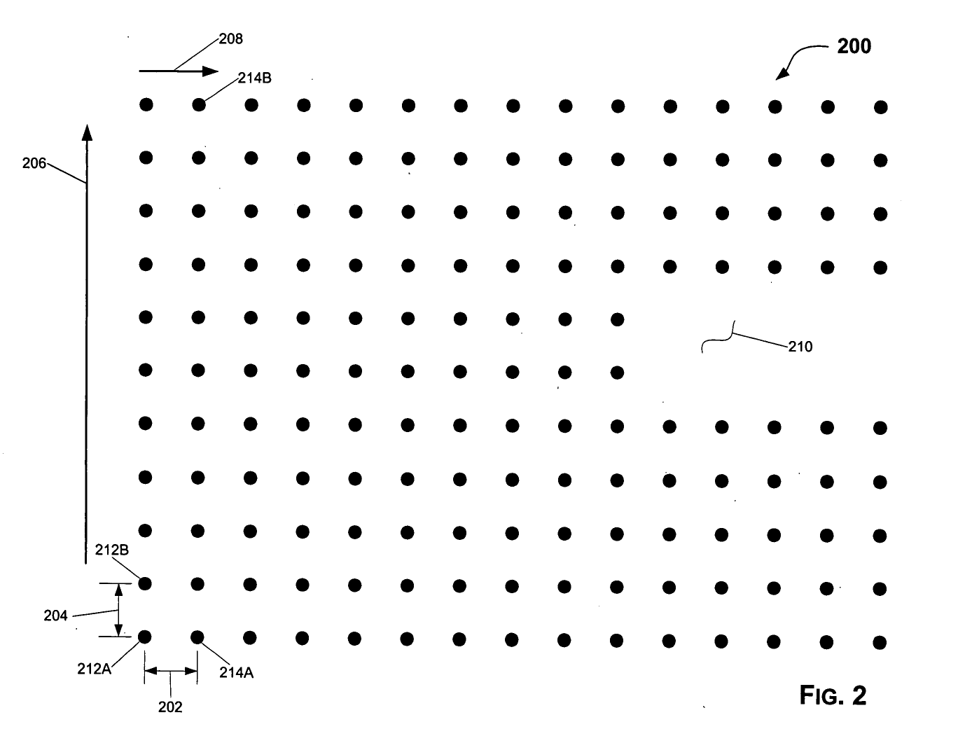

Once the data set has been created, the operation proceeds (either manually or autonomously) to illuminate the laser beam on the surface of object 10. Data is transferred to the x-y coordinate controller 6 and laser assembly 8 and the x-y coordinate controller 6 moves the laser assembly 8 in accordance with the program's parameters. In a preferred embodiment of the invention, the laser is directed to produce a pit or crater at some starting position. FIG. 2 illustrates a matte finish pattern resulting from the application of the laser beam to the surface of a surgical blade with carefully selected variables. The x-y coordinate controller 6 moves the laser assembly 8 continuously along the direction of arrow 206. The laser is turned on for a time t₁ (the “on” time) to create pit or crater 212A and then during time t₂ (the “off” time) the laser is turned off as it moves to the next desired position (pit or crater 212B). This pattern repeats according to the programmed data set, until a first row (or column) of pits or craters are produced. The laser then moves (in this example, to the right) along the direction of arrow 208, and begins again at pit or crater 214A. In different embodiments of the present invention, the laser can begin creating pits or craters at position 214B In this preferred embodiment of the invention, the pits or craters are generally circular patterns, although this may not be the case if the program calls for the lens assembly to alter the laser beam.

Typically, a gantry laser can be used to create the matte finish on the blades, or a galvo-head laser machine can be used. The former is slow, but extremely accurate, and the latter is fast, but not as accurate as the gantry. Since the overall accuracy is not vital, and speed of manufacturing directly affects cost, the galvo-head laser machine is the preferred tool. It is capable of moving thousands of millimeters per second, providing an overall ablated region etch time of about five seconds for a typical surgical blade.

After the first row of pits or craters have been created by the laser beam, the program turns off the laser as the x-y coordinate controller 6 moves the laser assembly 9 to the beginning of a new row (or column). The process then repeats until the desired design is finished. As FIG. 2 illustrates, there can be areas where no pits or craters have been made (area 210). Designs can be imparted on the matte finish object 10 with almost limitless possibilities. For example, a surgeon can have his or her name put on the silicon surgical blade, or a hospital can order the blade with the hospital's name on it. The program that creates the data set for the x-y coordinate controller 6 and laser assembly 8 preferably has an intuitive user interface that allows designers to create patterns, or import designs from other graphic arts programs. Such interactive software is well known to those skilled in the art.

In practice, a graphic file can be generated that randomly locates the depressions, but achieves the desired effect of a specific ablated region density and randomness to the pattern. This graphic file can be created manually, or automatically by a program in a computer. Other features that can be implemented are the inscriptions of serial numbers and manufacturer logos. The serial numbers or logos can either be created by pits or craters, or defined by or located in areas where there are no pits or craters. For example, in FIG. 2, area 210 is an area in which there are no pits or craters.

Table I illustrates the relationship between pulse repetition rates, surface velocity of the laser and subsequent spacing of pits or craters on a surgical blade made of silicon or other crystalline material, and FIG. 2 illustrates a matte finish pattern resulting from the application of the laser beam to a surgical blade with selected variables. As discussed above, the pulse repetition rate (PRR) is the rate (frequency) the laser is pulsed on and off. As one skilled in the art understands, the period is represented by T, which equals t₁ and t₂, the “on” time and “off” time, respectively, of the laser 8. If a first PRR equals 10 kHz, then T (the period) equals 0.100 ms. During the “on” time t₁, the laser is turned on at a position determined by the x-y coordinate controller 6, and a pit or crater is formed in the matte finish object 10. During time t₂, the “off” time, the laser is turned off and continues to move at a speed equal to a first surface velocity, SV-1, to the next position a pit or crater is to be formed. The distance between the center of each pit or crater, the “spacing”, is the product of the period T and SV-1: spacing=(SV-1)×(T). As an example, if SV-1 is 1,000 mm/s and T is 0.1 ms, then the pit or crater spacing equals 1,000 mm/s×0.1 ms, which equals 100 μm. FIG. 2 illustrates a matte finish using these variables. The spacing between each pit or crater in the first column is about 100 μm, as indicated by arrow 204. The diameter of the pit or crater is determined by the power, frequency (wavelength) and focus (through use of the lens in the laser and lens assembly 8) of the laser. The spacing between adjacent columns is indicated by arrow 202, which, in this non-limiting example, is about 150 μm. In FIG. 2, the matte finish design created by the operator includes an area 210 that has no pits or craters.

TABLE I

| Pulse Repetition | Surface Velocity | Crater |
|---|---|---|
| Rate (PRR) | (SV) | Spacing |
| 5 kHz | 1,000 mm/s | 200 μm |
| 5 kHz | 2,000 mm/s | 400 μm |
| 10 kHz | 1,000 mm/s | 100 μm |
| 10 kHz | 2,000 mm/s | 200 μm |

It is possible, with the appropriate laser, to create pits or craters on other materials besides silicon. These other materials can include all types of metals, glass, stone, plastic, wood, ceramics and virtually any other type of material in use. All that is required is the correct application of the control variables of laser frequency, laser power (average and peak), duty cycle, surface velocity and a system that can properly implement the control variables.

The present invention has been described with reference to an exemplary embodiment. However, it will be readily apparent to those skilled in the art that it is possible to embody the invention in specific forms other than that of the exemplary embodiment described above. This may be done without departing from the spirit and scope of the invention. The exemplary embodiment is merely illustrative and should not be considered restrictive in any way. The scope of the invention is given by the appended claims, rather than the preceding description, and all variations and equivalents that fall within the claims and their equivalents are intended to be covered.

1. A system for reducing glare and creating a matte finish design on a surface of an object, comprising:
an x-y coordinate controller adapted to process matte finish design commands; and
a laser assembly adapted to output a laser beam and be moved according to the processed matte finish design commands to produce the matte finish design on the surface of the object.

2. The system according to claim 1, further comprising:
a computer adapted to interact with a set of instruction code and a user to produce and transmit matte finish design commands to create the matte finish design on the surface of the object.

3. The system according to claim 2, wherein the instruction code comprises:
a set of computer instructions designed to interface with an operator to create matte finish designs on the computer and translate the design into commands and data readable by the x-y coordinate controller.

4. The system according to claim 1, wherein the laser assembly is selected from the group consisting of a gantry laser and a galvo-head laser.

5. The system according to claim 1, wherein the laser assembly comprises:
a laser adapted to output a light beam with a wavelength of about 355 nanometers, a pulse repetition rate between about 5 to 100 kHz, and a duty cycle of about 18×10⁻⁵ percent.

6. The system according to claim 5, wherein the laser is selected from the group consisting of an excimer laser and a YAG laser.

7. The system according to claim 6, wherein the laser is adapted to create substantially circular craters in the silicon surface ranging in diameter between about 25 to 50 microns and a depth of about 25 microns.

8. The system according to claim 1, wherein the laser assembly comprises a laser beam focusing assembly adapted to either focus the output laser beam to a smaller diameter laser beam than originally output, diverge the output laser beam to a larger diameter laser beam than originally output, or have substantially no effect on the output laser beam.

9. The system according to claim 1, wherein the x-y coordinate controller the laser assembly are adapted to move the laser at a surface velocity of about 1,000 mm/sec, to output a laser beam with a pulse repetition rate of about 5 kHz, and to create substantially circular craters spaced apart about 200 microns.

10. The system according to claim 1, wherein the x-y coordinate controller the laser assembly are adapted to move the laser at a surface velocity of about 2,000 mm/sec, to output a laser beam with a pulse repetition rate of about 5 kHz, and to create substantially circular craters spaced apart about 400 microns.

11. The system according to claim 1, wherein the x-y coordinate controller the laser assembly are adapted to move the laser at a surface velocity of about 1,000 mm/sec, to output a laser beam with a pulse repetition rate of about 10 kHz, and to create substantially circular craters spaced apart about 100 microns.

12. The system according to claim 1, wherein the x-y coordinate controller the laser assembly are adapted to move the laser at a surface velocity of about 2,000 mm/sec, to output a laser beam with a pulse repetition rate of about 10 kHz, and to create substantially circular craters spaced apart about 200 microns.

13. The system according to claim 1, wherein the object comprises a silicon surgical blade.

14. The system according to claim 1, wherein the object is made of silicon.

15. The system according to claim 1, wherein the object is made of a material selected from the group consisting of glass, ceramic, plastic, metal, wood and stone.

16. A method for reducing glare and creating a matte finish design on a surface of an object, comprising:
moving a laser assembly in an x-y coordinate controller in response to a series of matte finish design commands; and
outputting a laser beam from a laser in the laser assembly according to the matte finish design commands to produce the matte finish design on the surface of the object.

17. The method according to claim 16, further comprising:
creating a set of instruction code on a computer to produce matte finish design commands to create the matte finish design on the surface of an object;
transmitting the instruction code from the computer; and
receiving the matte finish design commands at the x-y coordinate controller.

18. The method according to claim 17, wherein the step of creating a set of instruction code on a computer comprises:
interfacing a set of computer instructions with an operator to create matte finish designs on the computer; and
translating the design into commands and data readable by the x-y coordinate controller.

19. The method according to claim 16, wherein the laser assembly is selected from the group consisting of a gantry laser and a galvo-head laser.

20. The method according to claim 16, wherein the step of outputting a laser beam from a laser in the laser assembly comprises:
outputting a light beam with a wavelength of about 355 nanometers, a pulse repetition rate between about 5 to 100 kHz, and a duty cycle of about 18×10⁻⁵ percent.

21. The method according to claim 16, wherein the laser is selected from the group consisting of an excimer laser and a YAG laser.

22. The method according to claim 16, wherein the step of outputting a laser beam from a laser in the laser assembly comprises:
creating substantially circular craters in the silicon surface ranging in diameter between about 25 to 50 microns and a depth of about 25 microns.

23. The method according to claim 16, wherein the step of outputting a laser beam from a laser in the laser assembly comprises:
focusing the output laser beam to a smaller diameter laser beam than originally output, diverging the output laser beam to a larger diameter laser beam than originally output or making substantially no changes to the output laser beam.

24. The method according to claim 16, wherein the steps of moving the laser assembly and outputting a laser beam from a laser in the laser assembly comprises:
moving the laser at a surface velocity of about 1,000 mm/sec; and
outputting a laser beam with a pulse repetition rate of about 5 kHz, to create substantially circular craters spaced apart about 200 microns.

25. The method according to claim 16, wherein the steps of moving the laser assembly and outputting a laser beam from a laser in the laser assembly comprises:
moving the laser at a surface velocity of about 2,000 mm/sec; and
outputting a laser beam with a pulse repetition rate of about 5 kHz, to create substantially circular craters spaced apart about 400 microns.

26. The method according to claim 16, wherein the steps of moving the laser assembly and outputting a laser beam from a laser in the laser assembly comprises:
moving the laser at a surface velocity of about 1,000 mm/sec; and
outputting a laser beam with a pulse repetition rate of about 10 kHz, to create substantially circular craters spaced apart about 100 microns.

27. The method according to claim 16, wherein the steps of moving the laser assembly and outputting a laser beam from a laser in the laser assembly comprises:
moving the laser at a surface velocity of about 2,000 mm/sec; and
outputting a laser beam with a pulse repetition rate of about 10 kHz, to create substantially circular craters spaced apart about 200 microns.

28. The method according to claim 16, wherein the object is a silicon surgical blade.

29. The method according to claim 16, wherein the object is made of a material selected from the group consisting of glass, ceramic, plastic, metal, wood and stone.

30. A product made according to the method of claim 16.

31. A silicon surgical blade made according to the method of claim 16.

32. An object having a matte finish on its surface, comprising:
a plurality of pits or craters on the surface of the object, of sufficient dimensions, to diffuse or scatter light, such that glare from the light is substantially reduced.

33. A method for reducing glare and creating a matte finish design on a surface of an object, comprising:
focusing a laser onto a surface of an object to create a plurality of craters of sufficient dimensions to diffuse or scatter light, such that glare from the light is substantially reduced.

34. The method according to claim 33, wherein the step of focusing a laser onto a surface of an object comprises:
creating a plurality of instructions to control the laser;
moving and manipulating the laser according to the plurality of instructions; and
outputting a laser beam from the laser according to the plurality of instructions onto the surface of the object to create the matte finish design.

35. The method according to claim 33, wherein the step of focusing a laser onto a surface of an object to create a plurality of craters comprises:
outputting a light beam with a wavelength of about 355 nanometers, a pulse repetition rate between about 5 to 100 kHz, and a duty cycle of about 18×10⁻⁵ percent.

36. The method according to claim 33, wherein the laser is selected from the group consisting of an excimer laser and a YAG laser.

37. The method according to claim 34, wherein the step of outputting a laser beam from the laser comprises:
creating substantially circular craters in the surface of the object ranging in diameter between about 25 to 50 microns and a depth of about 25 microns.

38. The method according to claim 33, wherein the step of focusing a laser onto a surface of an object to create a plurality of craters comprises:
focusing the output laser beam to a smaller diameter laser beam than originally output, diverging the output laser beam to a larger diameter laser beam than originally output or making substantially no changes to the output laser beam.

39. The method according to claim 34, wherein the steps of moving and manipulating the laser and outputting a laser beam from the laser comprises:
moving the laser at a surface velocity of about 1,000 mm/sec; and
outputting a laser beam with a pulse repetition rate of about 5 kHz, to create substantially circular craters spaced apart about 200 microns.

40. The method according to claim 34, wherein the steps of moving and manipulating the laser and outputting a laser beam from the laser comprises:
moving the laser at a surface velocity of about 2,000 mm/sec; and
outputting a laser beam with a pulse repetition rate of about 5 kHz, to create substantially circular craters spaced apart about 400 microns.

41. The method according to claim 34, wherein the steps of moving and manipulating the laser and outputting a laser beam from the laser comprises:
moving the laser at a surface velocity of about 1,000 mm/sec; and
outputting a laser beam with a pulse repetition rate of about 10 kHz, to create substantially circular craters spaced apart about 100 microns.

42. The method according to claim 34, wherein the steps of moving and manipulating the laser and outputting a laser beam from the laser comprises:
moving the laser at a surface velocity of about 2,000 mm/sec; and
outputting a laser beam with a pulse repetition rate of about 10 kHz, to create substantially circular craters spaced apart about 200 microns.

43. The method according to claim 33, wherein the object is a silicon surgical blade.

44. The method according to claim 33, wherein the object is made of a material selected from the group consisting of glass, ceramic, plastic, metal, wood and stone.

45. A product made according to the method of claim 33.

46. A silicon surgical blade made according to the method of claim 33.

47. The method according to claim 33, wherein the step of focusing a laser onto a surface of an object to create a plurality of craters comprises:
creating a plurality of substantially circular craters.
